(19) United States
(12) Patent Application Publication
(10) Pub. No.: US 2024/0342609 A1
(43) Pub. Date: Oct. 17, 2024

(54) GAME EQUIPMENT REPLACEMENT METHOD AND APPARATUS, STORAGE MEDIUM, AND ELECTRONIC DEVICE

(71) Applicant: NETEASE (HANGZHOU) NETWORK CO., LTD., Hangzhou, Zhejiang (CN)

(72) Inventor: Zhenyu LIU, Hangzhou, Zhejiang (CN)

(73) Assignee: NETEASE (HANGZHOU) NETWORK CO., LTD., Hangzhou, Zhejiang (CN)

(21) Appl. No.: 18/574,789

(22) PCT Filed: May 18, 2022
(86) PCT No.: PCT/CN2022/093643

§ 371 Date: Dec. 28, 2023

(30) Foreign Application Priority Data
Jul. 6, 2021 (CN) 202110763386.1

(51) Int. Cl. A63F 13/60; A63F 13/53; A63F 13/55; A63F 13/92

(52) U.S. Cl. CPC A63F 13/60; A63F 13/53; A63F 13/55; A63F 13/92; A63F 2300/308

(57) ABSTRACT

A game equipment replacement method includes providing a virtual equipment setting interface on a graphical user interface, in response to a virtual equipment scheme setting operation on the virtual equipment setting interface, setting an initial equipment scheme and setting replacement equipment for part or all of virtual equipment in the initial equipment scheme, providing a shortcut equipment configuration control on the graphical user interface and configuring corresponding virtual equipment for the player virtual character, setting at least one of an equipment skill trigger control or an equipment skill state control of target virtual equipment, displaying an equipment replacement control of the target virtual equipment at a position associated with the at least one of the equipment skill trigger control or the equipment skill state control, and replacing, in response to a trigger operation on the equipment replacement control, the target virtual equipment with corresponding replacement equipment.

### CROSS-REFERENCE TO RELATED APPLICATION

The present disclosure claims the priority to the Chinese Patent Application No. 202110763386.1, entitled “GAME EQUIPMENT REPLACEMENT METHOD AND APPARATUS, STORAGE MEDIUM, AND ELECTRONIC DEVICE”, filed on Jul. 6, 2021, and the entire contents of which are incorporated herein by reference.

### TECHNICAL FIELD

The present disclosure relates to the field of game technology, and in particular relates to a game equipment replacement method, a game equipment replacement apparatus, a computer-readable storage medium, and an electronic device.

### BACKGROUND

In current multiplayer online battle arena (MOBA) games, in order to quickly switch to equipment with specific functions during the game, players needs to perform the operations of “in the battle→open the store→click on the equipment that has lost its function →sell→find new equipment to re-purchase→click to buy→click to close, and return to the battle”.

This process is excessively complicated and lengthy, and requires the player to have extremely fast hand speed and high proficiency, which degrades gaming experience of the players. Moreover, since it is difficult for an ordinary player to complete the operations in a short period of time, the gap between the ordinary player and a high-end player becomes larger, which makes the gaming experience of the ordinary player worse and reduces the reflux degree of the player.

In view of this, there is an urgent need in this field to develop a new game equipment replacement method and apparatus.

It should be illustrated that the information disclosed in the above-described background section is only used for enhancing the understanding of the background of the present disclosure, and thus may include information that does not constitute prior art known to those ordinary skilled in the art.

### SUMMARY

An object of the present disclosure is to provide a game equipment replacement method, a game equipment replacement apparatus, a computer-readable storage medium, and an electronic device, thereby overcoming, at least to a certain extent, the problems of excessively complicated equipment replacement behavior and poor gaming experience caused by limitations of related arts.

Other characteristics and advantages of the present disclosure will become apparent through the following detailed description, or will be partially acquired through the practice of the present disclosure.

According to a first aspect of embodiments of the present disclosure, a game equipment replacement method is provided. A graphical user interface of a game is provided through a terminal device, the game includes a game scene and a player virtual character in the game scene, the player virtual character is configured to perform a game action based on a game instruction received by the graphical user interface, and method includes: providing a virtual equipment setting interface on the graphical user interface; in response to a virtual equipment scheme setting operation on the virtual equipment setting interface, setting an initial equipment scheme for the player virtual character, and setting replacement equipment for part or all of virtual equipment in the initial equipment scheme; providing, based on the initial equipment scheme, a shortcut equipment configuration control on the graphical user interface, and configuring, in response to a trigger operation on the shortcut equipment configuration control, corresponding virtual equipment for the player virtual character; when the player virtual character is configured with target virtual equipment, setting on the graphical user interface an equipment skill trigger control and/or an equipment skill state control of the target virtual equipment, where the equipment skill trigger control is used for actively triggering a game skill corresponding to the target virtual equipment, and the equipment skill state control is used for displaying an available state of the game skill corresponding to the target virtual equipment; displaying, in response to a preset display trigger event, an equipment replacement control of the target virtual equipment at a position associated with the equipment skill trigger control and/or the equipment skill state control; and replacing, in response to a trigger operation on the equipment replacement control, the target virtual equipment with corresponding replacement equipment.

In an embodiment of the present disclosure, the displaying, in response to the preset display trigger event, the equipment replacement control of the target virtual equipment at the position associated with the equipment skill trigger control and/or the equipment skill state control includes: determining, when the game skill corresponding to the target virtual equipment is in an unavailable state, whether the target virtual equipment satisfies a replacement condition of the replacement equipment corresponding to the target virtual equipment; and displaying, when determining that the target virtual equipment satisfies the replacement condition, the equipment replacement control of the target virtual equipment at the position associated with the equipment skill trigger control and/or the equipment skill state control.

In an embodiment of the present disclosure, the displaying, when determining that the target virtual equipment satisfies the replacement condition, the equipment replacement control of the target virtual equipment at the position associated with the equipment skill trigger control and/or the equipment skill state control includes: determining game resource data of the target virtual equipment and replacement resource data of the replacement equipment corresponding to the target virtual equipment, and obtaining remaining resource data; obtaining consumable resource data by performing a resource calculation on the game resource data and the remaining resource data; and if the consumable resource data is greater than or equal to the replacement resource data, determining that the target virtual equipment satisfies the replacement condition, and displaying the equipment replacement control of the target virtual equipment at the position associated with the equipment skill trigger control and/or the equipment skill state control.

In an embodiment of the present disclosure, the method further includes: determining game resource data of the target virtual equipment and replacement resource data of the replacement equipment corresponding to the target virtual equipment, and obtaining remaining resource data; obtaining consumable resource data by performing a resource calculation on the game resource data and the remaining resource data; and if the consumable resource data is less than the replacement resource data, determining that the target virtual equipment does not satisfy the replacement condition, and displaying the replacement equipment corresponding to the target virtual equipment in grey.

In an embodiment of the present disclosure, after the displaying the equipment replacement control of the target virtual equipment at the position associated with the equipment skill trigger control and/or the equipment skill state control, the method further includes: if the target virtual equipment corresponds to a plurality of replacement equipment, determining valid replacement equipment and invalid replacement equipment from the replacement equipment; displaying the valid replacement equipment differentially, and displaying the invalid replacement equipment in grey; and determining a target position of the valid replacement equipment that is displayed differentially to be the position associated with the equipment skill trigger control and/or the equipment skill state control, and displaying the equipment replacement control of the target virtual equipment at the target position.

In an embodiment of the present disclosure, the replacing, in response to the trigger operation on the equipment replacement control, the target virtual equipment with the corresponding replacement equipment includes: displaying, in response to a first trigger operation on the equipment replacement control, the replacement equipment corresponding to the target virtual equipment; determining, in response to a second trigger operation consecutive to the first trigger operation, that one piece of the valid replacement equipment as target replacement equipment; and replacing, in response to the second trigger operation terminating action, the target virtual equipment with the target replacement equipment.

In an embodiment of the present disclosure, the setting the replacement equipment for the part or all of the virtual equipment in the initial equipment scheme includes: providing an equipment setting control on the virtual equipment setting interface; selecting selectable equipment in response to a third trigger operation on the selectable equipment; and setting, in response to a fourth trigger operation on the equipment setting control, the selectable equipment as the replacement equipment for the part or all of the virtual equipment in the initial equipment scheme.

According to a second aspect of the embodiments of the present disclosure, a game equipment replacement apparatus is provided. A graphical user interface of a game is provided through a terminal device, the game includes a game scene and a player virtual character in the game scene, the player virtual character is configured to perform a game action based on a game instruction received by the graphical user interface, and the apparatus includes: an interface provision module, configured to provide a virtual equipment setting interface on the graphical user interface; a replacement configuration module, configured to, in response to a virtual equipment scheme setting operation on the virtual equipment setting interface, set an initial equipment scheme for the player virtual character, and set replacement equipment for part or all of virtual equipment in the initial equipment scheme; an equipment configuration module, configured to provide, based on the initial equipment scheme, a shortcut equipment configuration control on the graphical user interface, and configure, in response to a trigger operation on the shortcut equipment configuration control, corresponding virtual equipment for the player virtual character; a control setting module, configured to, when the player virtual character is configured with target virtual equipment, set on the graphical user interface an equipment skill trigger control and/or an equipment skill state control of the target virtual equipment, where the equipment skill trigger control is used for actively triggering a game skill corresponding to the target virtual equipment, and the equipment skill state control is used for displaying an available state of the game skill corresponding to the target virtual equipment; a control display module, configured to display, in response to a preset display trigger event, an equipment replacement control of the target virtual equipment at a position associated with the equipment skill trigger control and/or the equipment skill state control; and an equipment replacement module, configured to replace, in response to a trigger operation on the equipment replacement control, the target virtual equipment with corresponding replacement equipment.

According to a third aspect of the embodiments of the present disclosure, an electronic device is provided. The electronic device includes a processor and a memory. The memory stores a computer-readable instruction. The computer-readable instruction, when executed by the processor, implements the game equipment replacement method in any of the embodiments described above.

According to a fourth aspect of the embodiments of the present disclosure, a computer-readable storage medium is provided. The computer-readable storage medium stores a computer program. The computer program, when executed by a processor, implements the game equipment replacement method in any of the embodiments described above.

As can be seen from the above technical solutions, the game equipment replacement method, game equipment replacement apparatus, computer-readable storage medium, and electronic device in the embodiments of the present disclosure have at least the following advantages and positive effects.

In the method and apparatus provided by the embodiments of the present disclosure, the target virtual equipment is bound to the equipment replacement behavior of the player through the provided equipment replacement control, without the need for the player to perform lengthy and complex operations for equipment replacement, simplifying the time cost and calculation cost invested by the player in the operation process when replacing the equipment, gaining the player more battle time in the case of fierce battle conditions, and also reducing the urgency sense for the player to switch back and forth between the battle and the store, which makes the immersion of the player in the game stronger. Further, by completing the equipment replacement behavior through the trigger operation on the equipment replacement control, the operation steps of the player in displaying, selecting, and replacing the replacement equipment are reduced, the replacement experience and battle experience of the player are enhanced, and the gap between the ordinary player and the high-level player is narrowed, which to a certain extent improves the reflux degree of the player.

It should be understood that the above general description and the later detailed description are merely exemplary and explanatory and do not limit the present disclosure.

### BRIEF DESCRIPTION OF THE DRAWINGS

FIG. 1 schematically illustrates a schematic flowchart of a game equipment replacement method in an embodiment of the present disclosure.

FIG. 2 schematically illustrates a schematic flowchart of a method for setting replacement equipment for virtual equipment in an embodiment of the present disclosure.

FIG. 3 schematically illustrates a schematic flowchart of a method for displaying an equipment replacement control in an embodiment of the present disclosure.

FIG. 4 schematically illustrates a schematic flowchart of a method for further displaying an equipment replacement control in an embodiment of the present disclosure.

FIG. 5 schematically illustrates a schematic flowchart of a method for differentially displaying a plurality of replacement equipment in an embodiment of the present disclosure.

FIG. 6 schematically illustrates a schematic flowchart of a method for differentially displaying replacement equipment in an embodiment of the present disclosure.

FIG. 7 schematically illustrates a schematic flowchart of a method for replacing target virtual equipment with replacement equipment in an embodiment of the present disclosure.

FIG. 8 schematically illustrates a schematic interface diagram for setting replacement equipment by using an equipment setting control in an application scenario in an embodiment of the present disclosure.

FIG. 9 schematically illustrates a schematic interface diagram of displaying an equipment replacement control in an application scenario in an embodiment of the present disclosure.

FIG. 10 schematically illustrates a schematic interface diagram of an equipment replacement control in an application scenario in an embodiment of the present disclosure.

FIG. 11 schematically illustrates a schematic interface diagram for replacing target virtual equipment with replacement equipment in an application scenario in an embodiment of the present disclosure.

FIG. 12 schematically illustrates a schematic interface diagram for differentially displaying replacement equipment in different replacement conditions in an application scenario in an embodiment of the present disclosure.

FIG. 13 schematically illustrates a schematic structural diagram of a game equipment replacement apparatus in an embodiment of the present disclosure.

FIG. 14 schematically illustrates an electronic device for implementing a game equipment replacement method in an embodiment of the present disclosure.

FIG. 15 schematically illustrates a computer-readable storage medium for implementing a game equipment replacement method in an embodiment of the present disclosure.

### DETAILED DESCRIPTION

Example embodiments are now described more comprehensively with reference to the accompanying drawings. However, the example embodiments are capable of being implemented in a variety of forms and should not be construed as being limited to the examples set forth herein. Rather, the provision of these embodiments allows for the present disclosure to be more comprehensive and complete and conveys the idea of the example embodiments in a comprehensive manner to those skilled in the art. The described features, structures, or characteristics may be combined in one or more embodiments in any suitable manner. In the following description, many specific details are provided, thereby giving a full understanding of the embodiments of the present disclosure. However, those skilled in the art will realize that it is possible to practice the technical embodiments of the present disclosure and omit one or more of the particular details described, or that other methods, components, devices, steps, and the like may be used to practice the technical embodiments of the present disclosure. In other cases, the well-known technical solutions are not shown or described in detail to avoid overshadowing and obscuring aspects of the present disclosure.

The terms “a”, “an”, “said” and “the” are used in this specification to indicate the existence of one or more elements/components/etc. The terms “include” and “have” are used to indicate open inclusion and refer to the existence of additional elements/components/etc., in addition to the listed ones. The terms “first” and “second” etc. are used only as marks and do not limit the numbers of their objects.

Furthermore, the accompanying drawings are only schematic illustrations of the present disclosure and are not necessarily drawn to scale. The same reference numerals in the drawings represent the same or similar parts, and thus repetitive descriptions of them will be omitted. Some of the block diagrams shown in the accompanying drawings are functional entities and do not necessarily have to correspond to physically or logically separate entities.

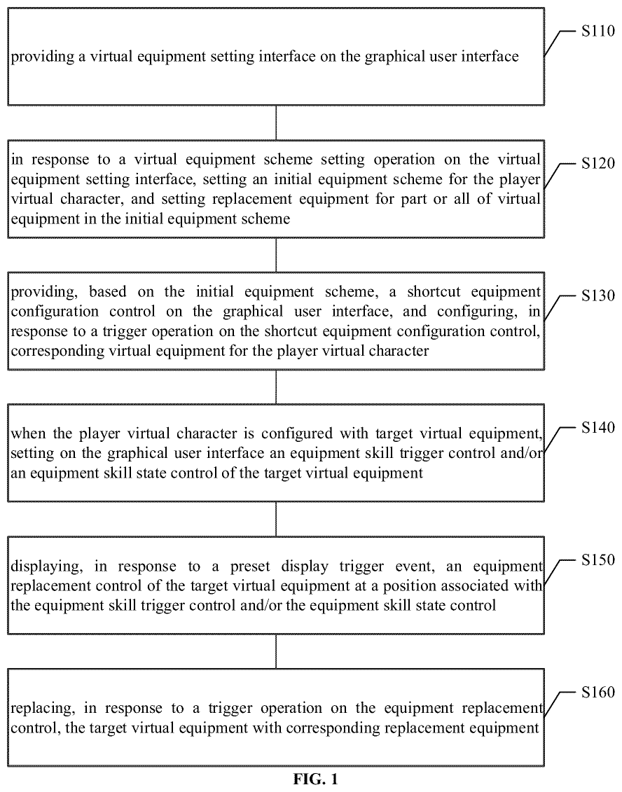

To cope with the problems in the related arts, the present disclosure proposes a game equipment replacement method. A graphical user interface of a game is provided through a terminal device, the game includes a game scene and a player virtual character in the game scene, and the player virtual character is configured to perform a game action based on a game instruction received by the graphical user interface. FIG. 1 illustrates a flowchart of a game equipment replacement method. As shown in FIG. 1, the game equipment replacement method at least includes the following steps S110 to S160.

At step S110, a virtual equipment setting interface is provided on the graphical user interface.

At step S120, in response to a virtual equipment scheme setting operation on the virtual equipment setting interface, an initial equipment scheme is set for the player virtual character, and replacement equipment is set for part or all of virtual equipment in the initial equipment scheme.

At step S130, a shortcut equipment configuration control is provided on the graphical user interface based on the initial equipment scheme, and corresponding virtual equipment is configured for the player virtual character in response to a trigger operation on the shortcut equipment configuration control.

At step S140, when the player virtual character is configured with target virtual equipment, an equipment skill trigger control and/or an equipment skill state control of the target virtual equipment is set on the graphical user interface, where the equipment skill trigger control is used for actively triggering a game skill corresponding to the target virtual equipment, and the equipment skill state control is used for displaying an available state of the game skill corresponding to the target virtual equipment.

At step S150, in response to a preset display trigger event, an equipment replacement control of the target virtual equipment is displayed at a position associated with the equipment skill trigger control and/or the equipment skill state control.

At step S160, the target virtual equipment is replaced with corresponding replacement equipment in response to a trigger operation on the equipment replacement control.

In the embodiments of the present disclosure, the target virtual equipment is bound to the equipment replacement behavior of the player through the provided equipment replacement control, without the need for the player to perform lengthy and complex operations for equipment replacement, simplifying the time cost and calculation cost invested by the player in the operation process when replacing the equipment, gaining the player more battle time in the case of fierce battle conditions, and also reducing the urgency sense for the player to switch back and forth between the battle and the store, which makes the immersion of the player in the game stronger. Further, by completing the equipment replacement behavior through the trigger operation on the equipment replacement control, the operation steps of the player in displaying, selecting, and replacing the replacement equipment are reduced, the replacement experience and battle experience of the player are enhanced, and the gap between the ordinary player and the high-level player is narrowed, which to a certain extent improves the reflux degree of the player.

The following provides a detailed description of the various steps in the game equipment replacement method.

In the step S110, the virtual equipment setting interface is provided on the graphical user interface.

In an embodiment of the present disclosure, the virtual equipment setting interface may be an interface used by the player to configure the initial equipment scheme for the player virtual character.

In the step S120, in response to the virtual equipment scheme setting operation on the virtual equipment setting interface, the initial equipment scheme is set for the player virtual character, and the replacement equipment is set for part or all of the virtual equipment in the initial equipment scheme.

In an embodiment of the present disclosure, when the player wants to configure the initial equipment scheme for the player virtual character, the configuration may be achieved through a setting operation on the virtual equipment setting interface. This setting operation may be a trigger operation, such as a click trigger operation, a long press trigger operation, or a sliding trigger operation. This embodiment does not make special limitations on this.

For example, the initial equipment scheme may be a combination of six pieces of initial virtual equipment that the player wants to equip on the player virtual character after entering the game, or other equipment scheme generated based on different games. This embodiment does not make special limitations on this.

Not only that, the player may also set corresponding replacement equipment for the initial equipment scheme.

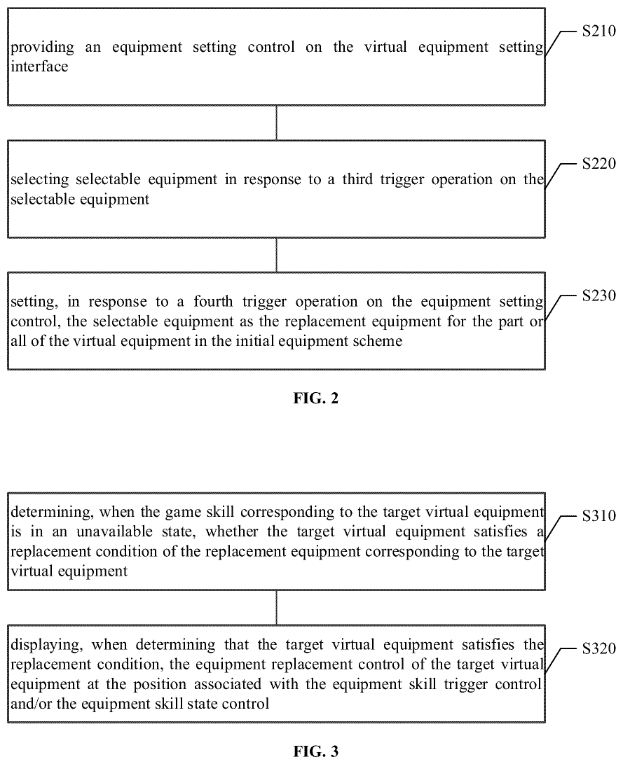

In an optional embodiment, FIG. 2 illustrates a schematic flowchart of a method for setting replacement equipment for virtual equipment. As shown in FIG. 2, the method at least includes the following steps S210 to S230. At step S210, an equipment setting control is provided on the virtual equipment setting interface.

Providing the equipment setting control on the virtual equipment setting interface, and using the equipment setting control may achieve that other virtual equipment that the player wants to use to replace the virtual equipment in the initial equipment scheme is set as the corresponding replacement equipment. This embodiment does not make special limitations on the setting position of the control on the interaction interface, as well as the attributes of the control such as the size, the number and the shape. The attributes and setting position of the control may be set artificially according to the actual situation.

It is worth stating that when the player wants to set corresponding replacement equipment for the virtual equipment in the initial equipment scheme through the equipment setting control, the player may set the replacement equipment for part or all of the virtual equipment in the initial equipment scheme by selecting one or more pieces or even all of the virtual equipment in the initial equipment scheme.

At step S220, selectable equipment is selected in response to a third trigger operation on the selectable equipment.

The selectable equipment may be all of the virtual equipment, or may be virtual equipment with a special effect. The special effect may be an effect that the virtual equipment is capable of providing other skills in the game for the player virtual character of the player. This embodiment does not make special limitations on this.

The player performs the third trigger operation on the control of the selectable equipment, and the trigger operation may be in the form of any operation such as a click operation, a long press operation, or a sliding operation. This embodiment does not make special limitations on this.

When the third trigger operation acts on the selectable equipment, it is indicated that the selectable equipment may be selected. Moreover, the third trigger operation may select one piece of selectable equipment, or may select a plurality of selectable equipment for batch setting, which may be set according to the game requirements. This embodiment does not make special limitations on this.

At step S230, in response to a fourth trigger operation on the equipment setting control, the selectable equipment is set as the replacement equipment for part or all of the virtual equipment in the initial equipment scheme.

After selecting the selectable equipment, the player may perform the fourth trigger operation on the equipment setting control, and this trigger operation may be in the form of any operation such as a click operation, a long press operation, or a sliding operation. This embodiment does not make special limitations on this.

Furthermore, when the fourth trigger operation acts on the equipment setting control, it is indicated that the selectable equipment that has been selected may be set as the corresponding replacement equipment.

The replacement equipment is a game equipment obtained by the player who wants to replace the currently used virtual equipment. Moreover, when the selectable equipment is a game equipment with a special effect, the replacement equipment is the virtual equipment with the special effect.

In this embodiment, the selectable equipment may be set as the replacement equipment through the equipment setting control. The setting manner is simple and accurate, and it can be set flexibly according to the game requirements, and is highly adaptable to the game scene.

In the step S130, the shortcut equipment configuration control is provided on the graphical user interface based on the initial equipment scheme, and corresponding virtual equipment is configured for the player virtual character in response to the trigger operation on the shortcut equipment configuration control.

In an embodiment of the present disclosure, in addition to providing the virtual equipment setting interface on the graphical user interface, the shortcut equipment configuration control may also be provided on the graphical user interface correspondingly.

The shortcut equipment configuration control may be used by the player to purchase virtual equipment required during the game process, or the virtual equipment that can be obtained by the player through triggering rewards during the game process through pre-setting of the gameplay, etc., i.e., the shortcut equipment configuration control is the control used by the player to obtain the virtual equipment for equipment needs, and this embodiment does not make special limitations on the specific manner of the obtaining.

Accordingly, corresponding virtual equipment may be purchased or obtained for the player virtual character through the trigger operation on the shortcut equipment configuration control. The trigger operation acting on the shortcut equipment configuration control may be a click operation, a long press operation, or a sliding operation, etc., and this embodiment does not make special limitations on this.

In the step S140, when the player virtual character is configured with the target virtual equipment, the equipment skill trigger control and/or the equipment skill state control of the target virtual equipment is set on the graphical user interface, where the equipment skill trigger control is used for actively triggering the game skill corresponding to the target virtual equipment, and the equipment skill state control is used for displaying the available state of the game skill corresponding to the target virtual equipment.

In an embodiment of the present disclosure, the target virtual equipment may be virtual equipment with a special effect, and the special effect may be that the virtual equipment is capable of providing an active or passive skill for the player virtual character in the game.

When the player virtual character is configured with the target virtual equipment with the special effect, the equipment skill trigger control and/or the equipment skill state control of the target virtual equipment may be further provided on the graphical user interface.

The equipment skill trigger control may be set for the target virtual equipment with an active skill.

Specifically, after the player configures the corresponding target virtual equipment for the player virtual character through the shortcut equipment configuration control, the player virtual character may simultaneously obtain the active skill carried by the target virtual equipment. The active skill may be triggered by a trigger operation on the equipment skill trigger control. For example, when the player virtual character clicks on the equipment skill trigger control, the active skill of the player virtual character may be triggered, so that the player virtual character is in an “invincible” state for a certain period of time, and is protected from the damage of the enemy virtual character.

The equipment skill state control may be set for the target virtual equipment with a passive skill.

Specifically, after the player configures the corresponding target virtual equipment for the player virtual character through the shortcut equipment configuration control, the player virtual character may simultaneously obtain the passive skill carried by the target virtual equipment. Since the passive skill cannot be actively triggered by the player, there is no corresponding equipment skill trigger control, and instead, the equipment skill state control may be displayed to show the player whether the passive skill carried by the target virtual equipment is in the available state, so that the player virtual character can passively trigger the passive skill carried by the target virtual equipment when the player virtual character meets an availability condition of the passive skill. For example, when the passive skill is to resurrect the player virtual character, it may be indicated that the player virtual character meets the availability condition of the passive skill when the player virtual character dies, and the target virtual equipment may resurrect the player virtual character.

In the step S150, in response to the preset display trigger event, the equipment replacement control of the target virtual equipment is displayed at the position associated with the equipment skill trigger control and/or the equipment skill state control.

In an embodiment of the present disclosure, in response to the preset display trigger event, the equipment replacement control of the target virtual equipment may be displayed at the associated position.

In an optional embodiment, FIG. 3 illustrates a schematic flowchart of a method for displaying an equipment replacement control. As shown in FIG. 3, the method at least includes the following steps S310 to S320. At step S310, when the game skill corresponding to the target virtual equipment is in an unavailable state, it is determined whether the target virtual equipment satisfies a replacement condition of the replacement equipment corresponding to the target virtual equipment.

The unavailable state may be a state in which the game skill corresponding to the target virtual equipment is in a cool down (CD) state or other situations in which the game skill is unavailable, for example, the number of times the game skill has been used reaches a limited number of times. The cool down state is cool down time of an item or skill in the game, and at this time the player may not continue to make use of the skill provided by the current virtual equipment.

Specifically, when the target virtual equipment carries an active skill, the unavailable state of the game skill may be a state in which the player is unable to trigger the equipment skill trigger control; and when the target virtual equipment carries a passive skill, the unavailable state of the game skill may be a state in which the player virtual character has not met the availability condition of the passive skill.

Regardless of whether the target virtual equipment carries an active skill or a passive skill, when the game skill corresponding to the target virtual equipment is in the unavailable state, the judgement of whether the equipment meets the replacement condition may be triggered for the target virtual equipment.

At step S320, when it is determined that the target virtual equipment satisfies the replacement condition, the equipment replacement control of the target virtual equipment is displayed at the position associated with the equipment skill trigger control and/or the equipment skill state control

In an optional embodiment, FIG. 4 illustrates a schematic flowchart of a method for further displaying an equipment replacement control. As shown in FIG. 4, the method at least includes the following steps S410 to S430. At step S410, game resource data of the target virtual equipment and replacement resource data of the replacement equipment corresponding to the target virtual equipment are determined, and remaining resource data is obtained.

The game resource data of the target virtual equipment may be a monetary value that can be obtained by selling the target virtual equipment, or may be other resource data that can be obtained by selling the target virtual equipment, and this embodiment does not make special limitations on this.

The replacement resource data of the replacement equipment may be a monetary value required to buy the replacement equipment or replace the replacement equipment, or may be other resource data for buying or replacing the replacement equipment, and this embodiment does not make special limitations on this.

The remaining resource data is the current remaining monetary value of the player, or other current remaining resource data of the player, and this embodiment does not make special limitations on this.

At step S420, consumable resource data is obtained by performing a resource calculation on the game resource data and the remaining resource data.

After obtaining the game resource data of the target virtual equipment and the remaining resource data, the resource calculation, such as a summation calculation, may be performed on the game resource data and the remaining resource data to obtain the consumable resource data.

The consumable resource data is a sum of the remaining resource data and the game resource data for selling the target virtual equipment of the player, i.e., the resource data that the player can use after selling the target virtual equipment.

At step S430, if the consumable resource data is greater than or equal to the replacement resource data, it is determined that the target virtual equipment satisfies the replacement condition of the replacement equipment, and the equipment replacement control of the target virtual equipment is displayed at the position associated with the equipment skill trigger control and/or the equipment skill state control.

After obtaining the consumable resource data, the consumable resource data may be compared with the replacement resource data.

When the comparison result is that the consumable resource data is greater than or equal to the replacement resource data, it is indicated that the replacement equipment is sufficient to be purchased or replaced after selling the target virtual equipment, plus the remaining resource data of the player. Therefore, at this time, it is determined that the target virtual equipment satisfies the replacement condition for purchasing or replacing the replacement equipment.

Further, the equipment replacement control of the target virtual equipment may be displayed at a preset position on the interaction interface. The display position of the equipment replacement control is determined by the equipment skill trigger control and/or the equipment skill state control, i.e., the equipment replacement control is displayed at the position associated with the equipment skill trigger control and/or the equipment skill state control.

The associated position may be a position where the equipment skill trigger control or the equipment skill state control is located, or other positions associated with the equipment skill trigger control and/or the equipment skill state control may be set according to the game. This embodiment does not make special limitations on this.

Moreover, the equipment replacement control may be a control that displays textual information, for example, the textual information is “replaceable”; or the equipment replacement control may be icon information, numerical representation information, or other forms in which any player is able to trigger replacement of the target virtual equipment, and this embodiment does not make special limitations on this.

In this embodiment, by calculating and comparing the game resource data of the target virtual equipment, the replacement resource data of the replacement equipment, and the remaining resource data, the equipment replacement control may be displayed at the position associated with the equipment skill trigger control and/or the equipment skill state control to intuitively prompt the player whether the condition of the replacement equipment has been satisfied without the need for the player to conduct comparisons and judgements on his or her own, which reduces the calculation cost of the player, simplifies the player's judgement manner and process for the replacement condition, and optimizes the player experience in the judgement of the replacement condition.

In addition, for other comparison results of the game resource data of the target virtual equipment, the replacement resource data of the replacement equipment, and the remaining resource data, corresponding settings may also be made for the replacement equipment, such as setting the replacement equipment to be displayed in grey.

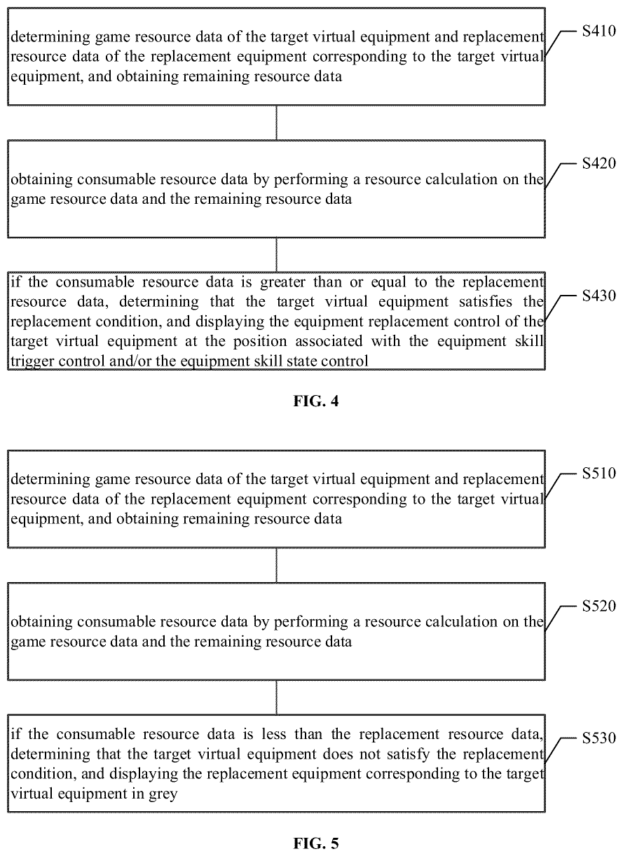

In an optional embodiment, FIG. 5 illustrates a schematic flowchart of a method for displaying the replacement equipment in grey. As shown in FIG. 5, the method at least includes the following steps S510 to S530. At step S510, game resource data of the target virtual equipment and replacement resource data of the replacement equipment corresponding to the target virtual equipment are determined, and remaining resource data is obtained.

The game resource data of the target virtual equipment may be a monetary value that can be obtained by selling the target virtual equipment, or may be other resource data that can be obtained by selling the target virtual equipment, and this embodiment does not make special limitations on this.

The replacement resource data of the replacement equipment may be a monetary value required to buy the replacement equipment or replace the replacement equipment, or may be other resource data for buying or replacing the replacement equipment, and this embodiment does not make special limitations on this.

The remaining resource data is the current remaining monetary value of the player, or other current remaining resource data of the player, and this embodiment does not make special limitations on this.

At step S520, consumable resource data is obtained by performing a resource calculation on the game resource data and the remaining resource data.

After obtaining the game resource data of the current game equipment and the remaining resource data, the resource calculation, such as a summation calculation, may be performed on the game resource data and the remaining resource data to obtain the consumable resource data.

The consumable resource data is a sum of the remaining resource data and the game resource data for selling the target virtual equipment of the player, i.e., the resource data that the player can use after selling the target virtual equipment.

At step S530, if the consumable resource data is less than the replacement resource data, it is determined that the target virtual equipment does not satisfy the replacement condition, and the replacement equipment corresponding to the target virtual equipment is displayed in grey.

After obtaining the consumable resource data, the consumable resource data may be compared with the replacement resource data.

When the comparison result is that the consumable resource data is less than the replacement resource data, it is indicated that the replacement equipment is not sufficient to be purchased or replaced after selling the target virtual equipment, plus the remaining resource data of the player. Therefore, at this time, it is determined that the target virtual equipment does not satisfy the replacement condition for purchasing or replacing the replacement equipment.

Further, the replacement equipment that cannot be purchased or replaced by the player may be displayed in grey to show the player that the replacement equipment cannot be replaced with the target virtual equipment.

In this embodiment, by calculating and comparing the game resource data of the target virtual equipment, the replacement resource data of the replacement equipment, and the remaining resource data, the equipment replacement may be displayed in grey to intuitively prompt the player that the condition of the replacement equipment is not satisfied without the need for the player to conduct comparisons and judgements on his or her own, which reduces the calculation cost of the player during the game process, simplifies the player's judgement manner and process for the replacement condition, and optimizes the player experience in the judgement of the replacement condition.

Furthermore, when the player sets a plurality of replacement equipment for the target virtual equipment, the plurality of replacement equipment may be differentially displayed.

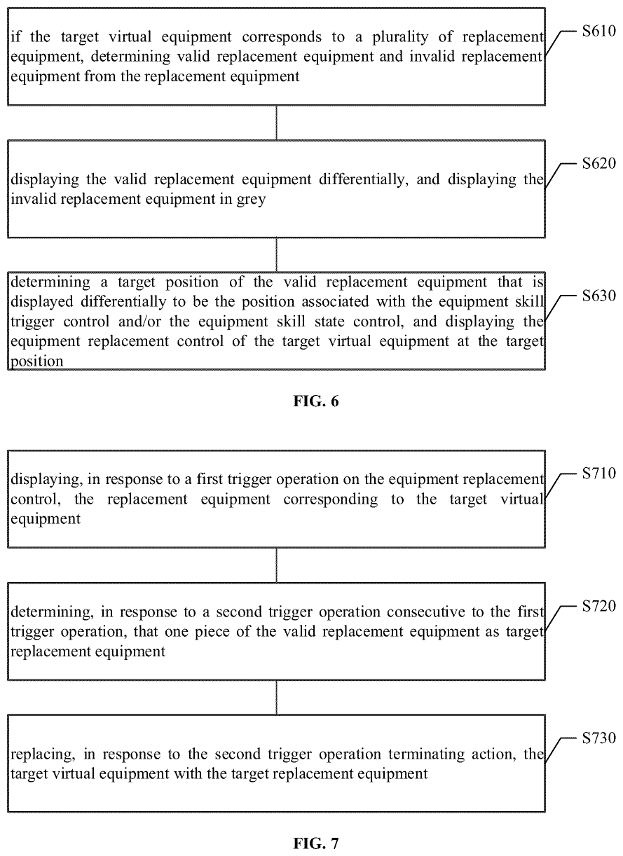

In an optional embodiment, FIG. 6 illustrates a schematic flowchart of a method for differentially displaying a plurality of replacement equipment. As shown in FIG. 6, the method at least includes the following steps S610 to S630. At step S610, if the target virtual equipment corresponds to a plurality of replacement equipment, valid replacement equipment and invalid replacement equipment are determined from the replacement equipment.

Since the player may set one or more pieces of replacement equipment for the target virtual equipment through the equipment setting control, then, when the player sets a plurality of replacement equipment for the target virtual equipment, the target virtual equipment corresponds to a plurality of replacement equipment.

However, the game resource data of the target virtual equipment and the remaining resource data may not necessarily satisfy the replacement condition of the plurality of replacement equipment, and therefore, the plurality of replacement equipment may be differentiated into valid replacement equipment and invalid replacement equipment based on whether the consumable resource data including the game resource data and the remaining resource data is less than the replacement resource data.

When the consumable resource data including the game resource data and the remaining resource data is greater than or equal to the replacement resource data, the replacement equipment is the valid replacement equipment; and when the consumable resource data including the game resource data and the remaining resource data is less than the replacement resource data, the replacement equipment is the invalid replacement equipment.

At step S620, the valid replacement equipment is displayed differentially, and the invalid replacement equipment is displayed in grey.

In order to facilitate the player to differentiate between the valid replacement equipment and the invalid replacement equipment, the invalid replacement equipment may be displayed in grey to show the non-replaceable state of the current invalid replacement equipment, and the valid replacement equipment may be differentially displayed, e.g., by highlighting, flashing, etc., in order to draw the attention of the player for replacement.

The manner of differentially displaying the valid replacement equipment may be differentiated from the manner of displaying the equipment before the replacement condition is determined. For example, the manner of differentially displaying may also be a lighting display, a flashing display, or a display that changes the color or size, or there may be other displaying manners that are different from the previous state. This embodiment does not make special limitations on this.

At step S630, a target position of the valid replacement equipment that is displayed differentially is determined to be the position associated with the equipment skill trigger control and/or the equipment skill state control, and the equipment replacement control of the target virtual equipment is displayed at the target position.

Further, the target position of the valid replacement equipment that has been differentially displayed may be determined to be the position associated with the equipment skill trigger control and/or the equipment skill state control to display the equipment replacement control at the target position.

In this embodiment, a display indication is made for a situation in which the target virtual equipment is configured with a plurality of replacement equipment, which facilitates the player to quickly grasp the state indicating whether each piece of the replacement equipment is capable of being replaced among the plurality of replacement equipment, eliminates the replacement cost for the player to consider on his or her own, gains the player more battle time in the tense and fierce battle conditions, and optimizes the battle and gaming experience of the player.

In the step S160, the target virtual equipment is replaced with the corresponding replacement equipment in response to the trigger operation on the equipment replacement control.

In an embodiment of the present disclosure, after the equipment replacement control is displayed, the target virtual equipment may be replaced with the corresponding replacement equipment through the equipment replacement control.

In an optional embodiment, FIG. 7 illustrates a schematic flowchart of a method for replacing target virtual equipment with replacement equipment. As shown in FIG. 7, the method at least includes the following steps S710 to S730. At step S710, the replacement equipment corresponding to the target virtual equipment is displayed in response to a first trigger operation on the equipment replacement control.

The player may display the replacement equipment, that has been set, through the first trigger operation on the equipment replacement control.

That is, after the player sets the replacement equipment, the replacement equipment does not need to be displayed on the interaction interface at all times, and the replacement equipment may be hidden when the player does not perform the first trigger operation, so as to save the display space of the interaction interface, and also to reduce the interference in the game process for the player.

When the player performs the first trigger operation, the replacement equipment is displayed so as to facilitate the player to query the options of the replacement equipment, without requiring the player to memorize the setting of the replacement equipment, which reduces the game burden of the player.

The first trigger operation may also be a trigger operation in any form, such as a click operation, a long press operation, or a sliding operation. This embodiment does not make special limitations on this.

At step S720, one piece of the valid replacement equipment is determined as target replacement equipment in response to a second trigger operation consecutive to the first trigger operation.

For example, when the first trigger operation is a click operation or a long press operation, the player may subsequently perform a sliding operation consecutive to the first trigger operation, to slide to the valid replacement equipment that is desired to be replaced to select the valid replacement equipment as the target replacement equipment.

The sliding operation is the second trigger operation. In addition, the second trigger operation may also be a click operation or a long press operation that is consecutive to the first trigger operation in time sequence. This embodiment does not make special limitations on this.

At step S730, the target virtual equipment is replaced with the target replacement equipment in response to the second trigger operation terminating action.

After determining the target replacement equipment, the player may release the hand to terminate the action of the second trigger operation and simultaneously complete the action of replacing the target virtual equipment with the target replacement equipment.

It is worth stating that the second trigger operation is consecutive to the first trigger operation, so the starting point of the action of the second trigger operation is the target virtual equipment. After the second trigger operation performs the operation of selecting the target replacement equipment, the second trigger operation needs to terminate its action on the target replacement equipment in order to complete the replacement action.

In this embodiment, the second trigger operation can consecutively complete the two actions of selecting and replacing the replacement equipment, which simplifies the interactive operation process of the player, also improves the efficiency and speed of the equipment replacement, gaining the player more battle time in the case of fierce battle conditions, optimizing the use experience and gaming experience of the player, and improving the reflux degree of the player.

The following is a detailed description of the game equipment replacement method in the embodiments of the present disclosure in combination with an application scenario.

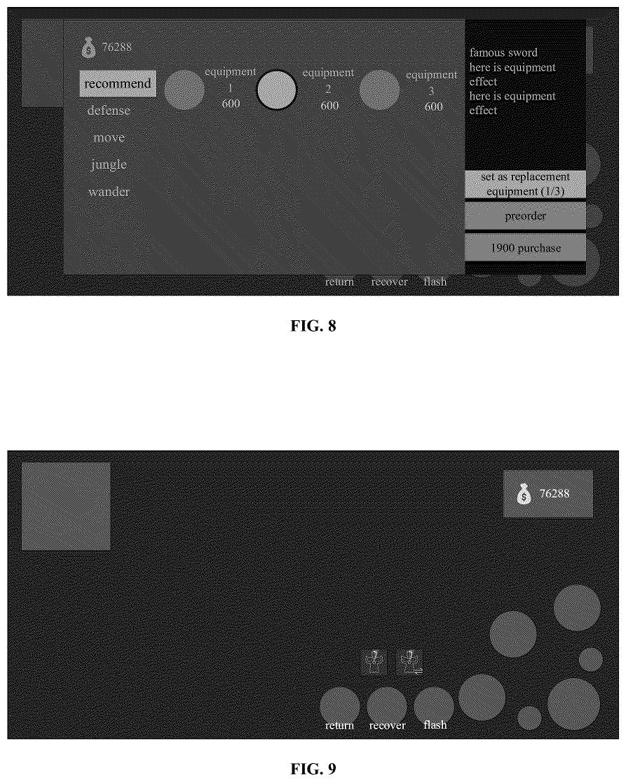

FIG. 8 illustrates a schematic interface diagram for setting replacement equipment by using an equipment setting control in an application scenario. As shown in FIG. 8, there are three pieces of selectable equipment in the backpack of the player, which are equipment 1, equipment 2, and equipment 3.

The selectable equipment may be virtual equipment with a special effect, the special effect may be an effect that the virtual equipment is capable of providing other skills in the game for the game character of the player, and the skill is differentiated into an active skill and a passive skill. This embodiment does not make special limitations on this.

Furthermore, an equipment setting control is provided on the interaction interface, and the equipment setting control is a “set as replacement equipment” control. The “set as replacement equipment” control may support setting the three pieces of selectable equipment as the replacement equipment.

The equipment setting control may be used to set the virtual equipment as the replacement equipment. This embodiment does not make special limitations on the setting position of the control on the interaction interface, as well as the attributes of the control such as the size, the number and the shape. The attributes and setting position of the control may be set artificially according to the actual situation.

FIG. 9 illustrates a schematic interface diagram of displaying an equipment replacement control in an application scenario. As shown in FIG. 9, when the game skill of the target virtual equipment is in an unavailable state, whether the target virtual equipment satisfies the replacement condition of the replacement equipment is determined.

After the player uses the target virtual equipment, the target virtual equipment may enter a CD state (i.e., a cool down state). The cool down state is cool down time of an item or skill in the game, and at this time the player may not continue to make use of the skill provided by the target virtual equipment.

Specifically, when the target virtual equipment carries an active skill, the unavailable state of the game skill may be a state in which the player is unable to trigger the equipment skill trigger control, for example, the game skill is in the cool down state, or the number of times the game skill has been used reaches a limited number of times, and at this time, the skill control corresponding to the active skill generally cannot be clicked. When the target virtual equipment carries a passive skill, the unavailable state of the game skill may be a state in which the player virtual character has not met the availability condition of the passive skill, for example, the game skill enters the cool down state, or the number of times the passive skill has been triggered reaches a limited number of times.

Regardless of whether the target virtual equipment carries an active skill or a passive skill, when the game skill corresponding to the target virtual equipment is in the unavailable state, the judgement of whether the equipment meets the replacement condition may be triggered for the target virtual equipment.

Thus, after the game skill of the target virtual equipment enters the unavailable state, whether the target virtual equipment satisfies the replacement condition of the replacement equipment may be determined.

The game resource data of the target virtual equipment and the replacement resource data of the replacement equipment corresponding to the target virtual equipment are determined, and the remaining resource data is obtained.

The game resource data of the target virtual equipment may be a monetary value that can be obtained by selling the target virtual equipment, or may be other resource data that can be obtained by selling the target virtual equipment, and this embodiment does not make special limitations on this.

The replacement resource data of the replacement equipment may be a monetary value required to buy the replacement equipment or replace the replacement equipment, or may be other resource data for buying or replacing the replacement equipment, and this embodiment does not make special limitations on this.

The remaining resource data is the current remaining monetary value of the player, or other current remaining resource data of the player, and this embodiment does not make special limitations on this.

Consumable resource data is obtained by performing a resource calculation on the game resource data and the remaining resource data.

After obtaining the game resource data of the target virtual equipment and the remaining resource data, the resource calculation, such as a summation calculation, may be performed on the game resource data and the remaining resource data to obtain the consumable resource data.

The consumable resource data is a sum of the remaining resource data and the game resource data for selling the target virtual equipment of the player, i.e., the resource data that the player can use after selling the target virtual equipment.

If the consumable resource data is greater than or equal to the replacement resource data, it is determined that the target virtual equipment satisfies the replacement condition of the replacement equipment, and the equipment replacement control of the target virtual equipment is displayed at the position associated with the equipment skill trigger control and/or the equipment skill state control.

After obtaining the consumable resource data, the consumable resource data may be compared with the replacement resource data.

When the comparison result is that the consumable resource data is greater than or equal to the replacement resource data, it is indicated that the replacement equipment is sufficient to be purchased or replaced after selling the target virtual equipment, plus the remaining resource data of the player. Therefore, at this time, it is determined that the target virtual equipment satisfies the replacement condition for purchasing or replacing the replacement equipment.

Further, the equipment replacement control of the target virtual equipment may be displayed at a preset position on the interaction interface. The display position of the equipment replacement control is determined by the equipment skill trigger control and/or the equipment skill state control, i.e., the equipment replacement control is displayed at the position associated with the equipment skill trigger control and/or the equipment skill state control.

The associated position may be a position where the equipment skill trigger control or the equipment skill state control is located, or other positions associated with the equipment skill trigger control and/or the equipment skill state control may be set according to the game. This embodiment does not make special limitations on this.

Moreover, the equipment replacement control may be a control that displays textual information, for example, the textual information is “replaceable”; or the equipment replacement control may be icon information, numerical representation information, or other forms in which any player is able to trigger replacement of the target virtual equipment, and this embodiment does not make special limitations on this.

When the comparison result is that the consumable resource data is less than the replacement resource data, it is indicated that the replacement equipment is not sufficient to be purchased or replaced after selling the target virtual equipment, plus the remaining resource data of the player. Therefore, at this time, it is determined that the target virtual equipment does not satisfy the replacement condition for purchasing or replacing the replacement equipment.

Further, the replacement equipment that cannot be purchased or replaced by the player may be displayed in grey to show the player that the replacement equipment cannot be replaced with the target virtual equipment.

Specifically, for the two pieces of target virtual equipment on the interaction interface, the target virtual equipment on the left is displayed in grey because the consumable resource data is less than the replacement resource data, while an equipment replacement control in the form of a double-arrow icon is displayed on the target virtual equipment on the right because the consumable resource data is greater than or equal to the replacement resource data.

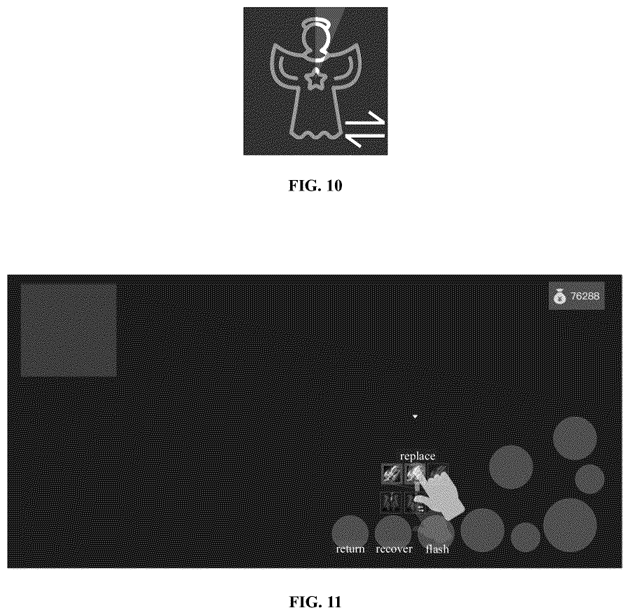

FIG. 10 illustrates a schematic interface diagram of an equipment replacement control in an application scenario. As shown in FIG. 10, the equipment replacement control is in the form of a double-arrow icon, and the double-arrow icon may be displayed in green or other colors in order to achieve prompt functions in various forms for the player. In addition, the equipment replacement control may also be a control in other forms, and this embodiment does not make special limitations on this.

FIG. 11 illustrates a schematic interface diagram for replacing target virtual equipment with replacement equipment in an application scenario. As shown in FIG. 11, the replacement equipment corresponding to the target virtual equipment is displayed in response to the first trigger operation on the equipment replacement control.

The player may display the replacement equipment, that has been set, through the first trigger operation on the equipment replacement control.

That is, after the player sets the replacement equipment, the replacement equipment does not need to be displayed on the interaction interface at all times, and the replacement equipment may be hidden when the player does not perform the first trigger operation, so as to save the display space of the interaction interface, and also to reduce the interference in the game process for the player.

When the player performs the first trigger operation, the replacement equipment is displayed so as to facilitate the player to query the options of the replacement equipment, without requiring the player to memorize the setting of the replacement equipment, which reduces the game burden of the player.

The first trigger operation may also be a trigger operation in any form, such as a click operation, a long press operation, or a sliding operation. This embodiment does not make special limitations on this.

Then, one piece of the valid replacement equipment is determined as the target replacement equipment in response to the second trigger operation consecutive to the first trigger operation.

For example, when the first trigger operation is a click operation or a long press operation, the player may subsequently perform a sliding operation consecutive to the first trigger operation, to slide to the valid replacement equipment that is desired to be replaced to select the valid replacement equipment as the target replacement equipment.

The sliding operation is the second trigger operation. In addition, the second trigger operation may also be a click operation or a long press operation that is consecutive to the first trigger operation in time sequence. This embodiment does not make special limitations on this.

Further, the target virtual equipment is replaced with the target replacement equipment in response to the second trigger operation consecutive to the first trigger operation terminating action.

After determining the target replacement equipment, the player may release the hand to terminate the action of the second trigger operation and simultaneously complete the action of replacing the target virtual equipment with the target replacement equipment.

It is worth stating that the second trigger operation is consecutive to the first trigger operation, so the starting point of the action of the second trigger operation is the target virtual equipment. After the second trigger operation performs the operation of selecting the target replacement equipment, the second trigger operation needs to terminate its action on the target replacement equipment in order to complete the replacement action.

When there is a plurality of replacement equipment, after the target replacement equipment is selected, the replacement equipment may be differentially displayed.

The manner of differentially displaying may be differentiated from the manner of displaying other replacement equipment that is not selected. For example, the manner of differentially displaying may be a lighting display, a flashing display, or a display that changes the color or size, or there may be other displaying manners. This embodiment does not make special limitations on this.

When there is only one piece of replacement equipment, the selected target replacement equipment is the replacement equipment. Then, the displaying of the target replacement equipment at this time may be differentiated from the displaying manner of the target replacement equipment before it is selected. For example, the manner of differentially displaying may also be a lighting display, a flashing display, or a display that changes the color or size, or there may be other displaying manners that are different from the previous state. This embodiment does not make special limitations on this.

When a certain piece of replacement equipment cannot be purchased or replaced with the remaining resource data even if the target virtual equipment is sold, the replacement equipment may be determined as the invalid replacement equipment of the current replacement. Moreover, the invalid replacement equipment may be displayed in grey in order to intuitively show the player that the replacement equipment cannot be selected or replaced.

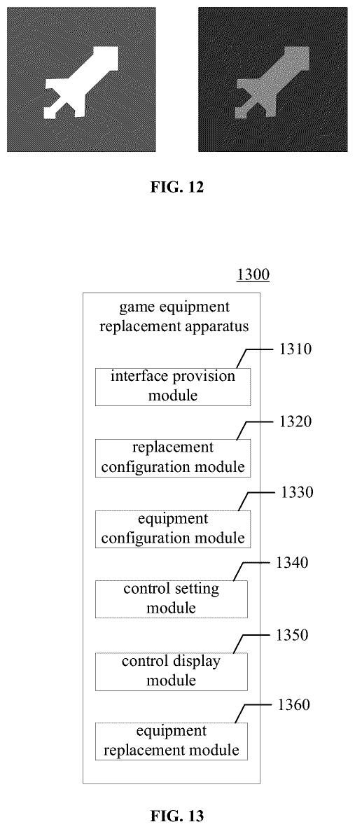

FIG. 12 illustrates a schematic interface diagram for differentially displaying replacement equipment in different replacement conditions in an application scenario. As shown in FIG. 12, when there is a plurality of replacement equipment, the target virtual equipment may be capable of satisfying the replacement condition of one or more pieces of replacement equipment, but it is also possible that the target virtual equipment may not be capable of satisfying the replacement condition of one or more pieces of replacement equipment, and thus the plurality of replacement equipment may be differentially displayed.

Determining one or more pieces of replacement equipment for which the target virtual equipment is capable of satisfying the replacement condition as the valid replacement equipment, it is indicated that the target virtual equipment may be replaced with the valid replacement equipment. Further, the manner of differentially displaying the valid replacement equipment may be a lighting display.

When a certain piece of replacement equipment cannot be purchased or replaced with the remaining resource data even if the target virtual equipment is sold, the replacement equipment may be determined as the invalid replacement equipment of the current replacement. Further, the invalid replacement equipment may be displayed in grey in order to intuitively show the player that the replacement equipment cannot be selected or replaced.

In the game equipment replacement method in this application scenario, the target virtual equipment is bound to the equipment replacement behavior of the player through the provided equipment replacement control, without the need for the player to perform lengthy and complex operations for equipment replacement, simplifying the time cost and calculation cost invested by the player in the operation process when replacing the equipment, gaining the player more battle time in the case of fierce battle conditions, and also reducing the urgency sense for the player to switch back and forth between the battle and the store, which makes the immersion of the player in the game stronger.

Further, by completing the equipment replacement behavior through the trigger operation on the equipment replacement control, the operation steps of the player in displaying, selecting, and replacing the replacement equipment are reduced, the replacement experience and battle experience of the player are enhanced, and the gap between the ordinary player and the high-level player is narrowed, which to a certain extent improves the reflux degree of the player.

In addition, in an embodiment of the present disclosure, a game equipment replacement apparatus is provided. A graphical user interface of a game is provided through a terminal device, the game includes a game scene and a player virtual character in the game scene, and the player virtual character is configured to perform a game action based on a game instruction received by the graphical user interface. FIG. 13 illustrates a schematic structural diagram of a game equipment replacement apparatus. As shown in FIG. 13, the game equipment replacement apparatus 1300 may include an interface provision module 1310, a replacement configuration module 1320, an equipment configuration module 1330, a control setting module 1340, a control display module 1350, and an equipment replacement module 1360.

The interface provision module 1310 is configured to provide a virtual equipment setting interface on the graphical user interface. The replacement configuration module 1320 is configured: in response to a virtual equipment scheme setting operation on the virtual equipment setting interface, set an initial equipment scheme for the player virtual character, and set replacement equipment for part or all of virtual equipment in the initial equipment scheme. The equipment configuration module 1330 is configured to provide, based on the initial equipment scheme, a shortcut equipment configuration control on the graphical user interface, and configure, in response to a trigger operation on the shortcut equipment configuration control, corresponding virtual equipment for the player virtual character. The control setting module 1340 is configured to: when the player virtual character is configured with target virtual equipment, set on the graphical user interface an equipment skill trigger control and/or an equipment skill state control of the target virtual equipment, where the equipment skill trigger control is used for actively triggering a game skill corresponding to the target virtual equipment, and the equipment skill state control is used for displaying an available state of the game skill corresponding to the target virtual equipment. The control display module 1350 is configured to display, in response to a preset display trigger event, an equipment replacement control of the target virtual equipment at a position associated with the equipment skill trigger control and/or the equipment skill state control. The equipment replacement module 1360 is configured to replace, in response to a trigger operation on the equipment replacement control, the target virtual equipment with corresponding replacement equipment.

In an embodiment of the present disclosure, the displaying, in response to the preset display trigger event, the equipment replacement control of the target virtual equipment at the position associated with the equipment skill trigger control and/or the equipment skill state control includes: determining, when the game skill corresponding to the target virtual equipment is in an unavailable state, whether the target virtual equipment satisfies a replacement condition of the replacement equipment corresponding to the target virtual equipment; and displaying, when determining that the target virtual equipment satisfies the replacement condition, the equipment replacement control of the target virtual equipment at the position associated with the equipment skill trigger control and/or the equipment skill state control.

In an embodiment of the present disclosure, the displaying, when determining that the target virtual equipment satisfies the replacement condition, the equipment replacement control of the target virtual equipment at the position associated with the equipment skill trigger control and/or the equipment skill state control includes: determining game resource data of the target virtual equipment and replacement resource data of the replacement equipment corresponding to the target virtual equipment, and obtaining remaining resource data; obtaining consumable resource data by performing a resource calculation on the game resource data and the remaining resource data; and if the consumable resource data is greater than or equal to the replacement resource data, determining that the target virtual equipment satisfies the replacement condition, and displaying the equipment replacement control of the target virtual equipment at the position associated with the equipment skill trigger control and/or the equipment skill state control.

In an embodiment of the present disclosure, the game equipment replacement method further includes: determining game resource data of the target virtual equipment and replacement resource data of the replacement equipment corresponding to the target virtual equipment, and obtaining remaining resource data; obtaining consumable resource data by performing a resource calculation on the game resource data and the remaining resource data; and if the consumable resource data is less than the replacement resource data, determining that the target virtual equipment does not satisfy the replacement condition, and displaying the replacement equipment corresponding to the target virtual equipment in grey.

In an embodiment of the present disclosure, after the displaying the equipment replacement control of the target virtual equipment at the position associated with the equipment skill trigger control and/or the equipment skill state control, the game equipment replacement method further includes: if the target virtual equipment corresponds to a plurality of replacement equipment, determining valid replacement equipment and invalid replacement equipment from the replacement equipment; displaying the valid replacement equipment differentially, and displaying the invalid replacement equipment in grey; and determining a target position of the valid replacement equipment that is displayed differentially to be the position associated with the equipment skill trigger control and/or the equipment skill state control, and displaying the equipment replacement control of the target virtual equipment at the target position.

In an embodiment of the present disclosure, the replacing, in response to the trigger operation on the equipment replacement control, the target virtual equipment with the corresponding replacement equipment includes: displaying, in response to a first trigger operation on the equipment replacement control, the replacement equipment corresponding to the target virtual equipment; determining, in response to a second trigger operation consecutive to the first trigger operation, that one piece of the valid replacement equipment as target replacement equipment; and replacing, in response to the second trigger operation terminating action, the target virtual equipment with the target replacement equipment.

In an embodiment of the present disclosure, the setting the replacement equipment for the part or all of the virtual equipment in the initial equipment scheme includes: providing an equipment setting control on the virtual equipment setting interface; selecting selectable equipment in response to a third trigger operation on the selectable equipment; and setting, in response to a fourth trigger operation on the equipment setting control, the selectable equipment as the replacement equipment for the part or all of the virtual equipment in the initial equipment scheme.

The specific details of the above-described game equipment replacement apparatus 1300 have already been described in detail in the corresponding game equipment replacement method, and therefore are not repeated herein.

It should be noted that although one or more modules or units of the game equipment replacement apparatus 1300 are mentioned in the detailed description above, such division is not mandatory. Indeed, according to the embodiments of the present disclosure, features and functions of two or more modules or units described above may be specified in a single module or unit. Conversely, features and functions of one module or unit described above may be further divided to be specified by a plurality of modules or units.

Furthermore, in an embodiment of the present disclosure, an electronic device capable of implementing the above-described method is provided.

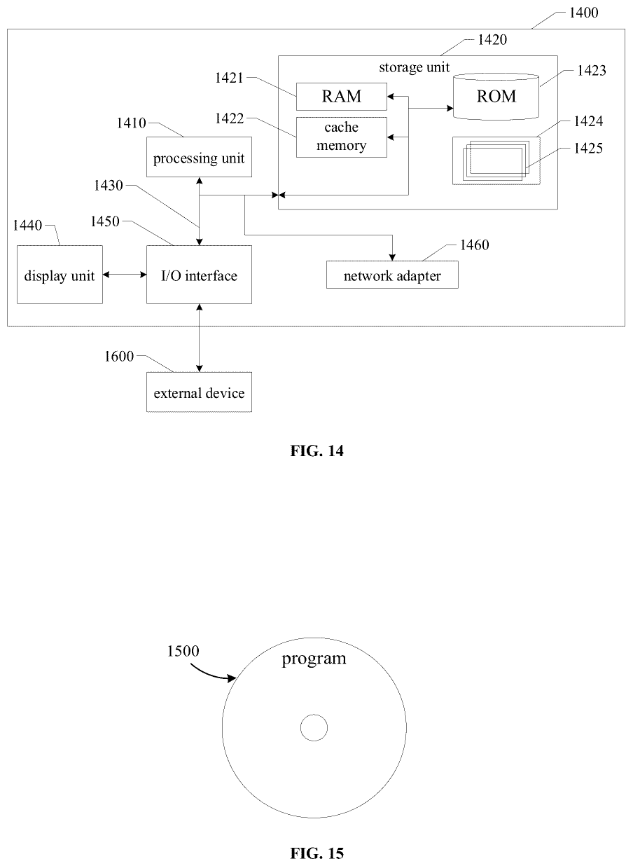

The electronic device 1400 according to such embodiments of the present disclosure is described below with reference to FIG. 14. The electronic device 1400 shown in FIG. 14 is merely an example and should not bring about any limitation on the function and scope of use of the embodiments of the present disclosure.

As shown in FIG. 14, the electronic device 1400 is represented in the form of a general purpose computing device. Components of the electronic device 1400 may include, but are not limited to, at least one processing unit 1410 described above, at least one storage unit 1420 described above, a bus 1430 connecting different system components including the storage unit 1420 and the processing unit 1410, and a display unit 1440.

The memory unit stores program code. The program code may be executed by the processing unit 1410 such that the processing unit 1410 performs the steps according to various embodiments of the present disclosure described in the above-described “method” section of this specification. An example is shown below.

A graphical user interface of a game is provided through a terminal device, the game includes a game scene and a player virtual character in the game scene, the player virtual character is configured to perform a game action based on a game instruction received by the graphical user interface, and method includes: providing a virtual equipment setting interface on the graphical user interface; in response to a virtual equipment scheme setting operation on the virtual equipment setting interface, setting an initial equipment scheme for the player virtual character, and setting replacement equipment for part or all of virtual equipment in the initial equipment scheme; providing, based on the initial equipment scheme, a shortcut equipment configuration control on the graphical user interface, and configuring, in response to a trigger operation on the shortcut equipment configuration control, corresponding virtual equipment for the player virtual character; when the player virtual character is configured with target virtual equipment, setting on the graphical user interface an equipment skill trigger control and/or an equipment skill state control of the target virtual equipment, where the equipment skill trigger control is used for actively triggering a game skill corresponding to the target virtual equipment, and the equipment skill state control is used for displaying an available state of the game skill corresponding to the target virtual equipment; displaying, in response to a preset display trigger event, an equipment replacement control of the target virtual equipment at a position associated with the equipment skill trigger control and/or the equipment skill state control; and replacing, in response to a trigger operation on the equipment replacement control, the target virtual equipment with corresponding replacement equipment.

Optionally, the displaying, in response to the preset display trigger event, the equipment replacement control of the target virtual equipment at the position associated with the equipment skill trigger control and/or the equipment skill state control includes: determining, when the game skill corresponding to the target virtual equipment is in an unavailable state, whether the target virtual equipment satisfies a replacement condition of the replacement equipment corresponding to the target virtual equipment; and displaying, when determining that the target virtual equipment satisfies the replacement condition, the equipment replacement control of the target virtual equipment at the position associated with the equipment skill trigger control and/or the equipment skill state control.

Optionally, the displaying, when determining that the target virtual equipment satisfies the replacement condition, the equipment replacement control of the target virtual equipment at the position associated with the equipment skill trigger control and/or the equipment skill state control includes: determining game resource data of the target virtual equipment and replacement resource data of the replacement equipment corresponding to the target virtual equipment, and obtaining remaining resource data; obtaining consumable resource data by performing a resource calculation on the game resource data and the remaining resource data; and if the consumable resource data is greater than or equal to the replacement resource data, determining that the target virtual equipment satisfies the replacement condition, and displaying the equipment replacement control of the target virtual equipment at the position associated with the equipment skill trigger control and/or the equipment skill state control.

Optionally, the method further includes: determining game resource data of the target virtual equipment and replacement resource data of the replacement equipment corresponding to the target virtual equipment, and obtaining remaining resource data; obtaining consumable resource data by performing a resource calculation on the game resource data and the remaining resource data; and if the consumable resource data is less than the replacement resource data, determining that the target virtual equipment does not satisfy the replacement condition, and displaying the replacement equipment corresponding to the target virtual equipment in grey.

Optionally, after the displaying the equipment replacement control of the target virtual equipment at the position associated with the equipment skill trigger control and/or the equipment skill state control, the method further includes: if the target virtual equipment corresponds to a plurality of replacement equipment, determining valid replacement equipment and invalid replacement equipment from the replacement equipment; displaying the valid replacement equipment differentially, and displaying the invalid replacement equipment in grey; and determining a target position of the valid replacement equipment that is displayed differentially to be the position associated with the equipment skill trigger control and/or the equipment skill state control, and displaying the equipment replacement control of the target virtual equipment at the target position.

Optionally, the replacing, in response to the trigger operation on the equipment replacement control, the target virtual equipment with the corresponding replacement equipment includes: displaying, in response to a first trigger operation on the equipment replacement control, the replacement equipment corresponding to the target virtual equipment; determining, in response to a second trigger operation consecutive to the first trigger operation, that one piece of the valid replacement equipment as target replacement equipment; and replacing, in response to the second trigger operation terminating action, the target virtual equipment with the target replacement equipment.

Optionally, the setting the replacement equipment for the part or all of the virtual equipment in the initial equipment scheme includes: providing an equipment setting control on the virtual equipment setting interface; selecting selectable equipment in response to a third trigger operation on the selectable equipment; and setting, in response to a fourth trigger operation on the equipment setting control, the selectable equipment as the replacement equipment for the part or all of the virtual equipment in the initial equipment scheme.

Through the above manners, the target virtual equipment is bound to the equipment replacement behavior of the player through the provided equipment replacement control, without the need for the player to perform lengthy and complex operations for equipment replacement, simplifying the time cost and calculation cost invested by the player in the operation process when replacing the equipment, gaining the player more battle time in the case of fierce battle conditions, and also reducing the urgency sense for the player to switch back and forth between the battle and the store, which makes the immersion of the player in the game stronger. Further, by completing the equipment replacement behavior through the trigger operation on the equipment replacement control, the operation steps of the player in displaying, selecting, and replacing the replacement equipment are reduced, the replacement experience and battle experience of the player are enhanced, and the gap between the ordinary player and the high-level player is narrowed, which to a certain extent improves the reflux degree of the player.

The storage unit 1420 may include a readable medium in the form of a volatile storage unit, such as a random access memory (RAM) unit 1421 and/or a cache memory unit 1422, and may further include a read-only memory (ROM) unit 1423.

The storage unit 1420 may also include a program/utility tool 1424 having a set (at least one) of program modules 1425, and such program module 1425 includes, but is not limited to, an operating system, one or more application programs, other program modules, and program data. An implementation of a network environment may be included in each of these examples or a certain combination thereof.

The bus 1430 may represent one or more types of bus structures, including a storage unit bus or storage unit controller, peripheral bus, graphics acceleration port, processing unit, or local area bus using any of the various bus structures.

The electronic device 1400 may also communicate with one or more external devices 1600 (e.g., keyboards, pointing devices, Bluetooth devices), and may also communicate with one or more devices that enable a user to interact with the electronic device 1400, and/or may also communicate with any device (e.g., routers, modems) that enables the electronic device 1400 to communicate with one or more other computing devices. Such communication may be carried out via an input/output (I/O) interface 1450. And, the electronic device 1400 may also communicate with one or more networks (e.g., a local area network (LAN), a wide area network (WAN), and/or a public network, such as the internet) via a network adapter 1460. As shown in the drawing, the network adapter 1440 communicates with other modules of the electronic device 1400 via the bus 1430. It should be appreciated that, although not shown in the drawings, other hardware and/or software modules may be used in conjunction with the electronic device 1400, including, but not limited to, microcode, device drives, redundant processing units, external disk drive arrays, RAID systems, tape drives, data backup storage systems, etc.

Through the above description of the embodiments, it is readily understood by those skilled in the art that the example embodiments described herein may be implemented by software or may be implemented by software in combination with the necessary hardware. Thus, the technical solutions according to the embodiments of the present disclosure may be embodied in the form of a software product. The software product may be stored in a non-volatile storage medium (which may be a CD-ROM, a USB flash drive, a removable hard drive, and the like) or on a network, and include one or more instructions to enable a computing device (which may be a personal computer, a server, a terminal device, or a network device, and the like) to perform the method according to the embodiments of the present disclosure.

In an embodiment of the present disclosure, a computer-readable storage medium is provided. The computer-readable storage medium stores a program product capable of implementing the method described above in this specification. In some possible embodiments, aspects of the present disclosure may also be implemented in the form of a program product including program code. When the program product is run on a terminal device, the program code is used for causing the terminal device to perform the steps according to various embodiments of the present disclosure described in the above-described “method” section of this specification. An example is shown below.

A graphical user interface of a game is provided through a terminal device, the game includes a game scene and a player virtual character in the game scene, the player virtual character is configured to perform a game action based on a game instruction received by the graphical user interface, and method includes: providing a virtual equipment setting interface on the graphical user interface; in response to a virtual equipment scheme setting operation on the virtual equipment setting interface, setting an initial equipment scheme for the player virtual character, and setting replacement equipment for part or all of virtual equipment in the initial equipment scheme; providing, based on the initial equipment scheme, a shortcut equipment configuration control on the graphical user interface, and configuring, in response to a trigger operation on the shortcut equipment configuration control, corresponding virtual equipment for the player virtual character; when the player virtual character is configured with target virtual equipment, setting on the graphical user interface an equipment skill trigger control and/or an equipment skill state control of the target virtual equipment, where the equipment skill trigger control is used for actively triggering a game skill corresponding to the target virtual equipment, and the equipment skill state control is used for displaying an available state of the game skill corresponding to the target virtual equipment; displaying, in response to a preset display trigger event, an equipment replacement control of the target virtual equipment at a position associated with the equipment skill trigger control and/or the equipment skill state control; and replacing, in response to a trigger operation on the equipment replacement control, the target virtual equipment with corresponding replacement equipment.

Optionally, the displaying, in response to the preset display trigger event, the equipment replacement control of the target virtual equipment at the position associated with the equipment skill trigger control and/or the equipment skill state control includes: determining, when the game skill corresponding to the target virtual equipment is in an unavailable state, whether the target virtual equipment satisfies a replacement condition of the replacement equipment corresponding to the target virtual equipment; and displaying, when determining that the target virtual equipment satisfies the replacement condition, the equipment replacement control of the target virtual equipment at the position associated with the equipment skill trigger control and/or the equipment skill state control.

Optionally, the displaying, when determining that the target virtual equipment satisfies the replacement condition, the equipment replacement control of the target virtual equipment at the position associated with the equipment skill trigger control and/or the equipment skill state control includes: determining game resource data of the target virtual equipment and replacement resource data of the replacement equipment corresponding to the target virtual equipment, and obtaining remaining resource data; obtaining consumable resource data by performing a resource calculation on the game resource data and the remaining resource data; and if the consumable resource data is greater than or equal to the replacement resource data, determining that the target virtual equipment satisfies the replacement condition, and displaying the equipment replacement control of the target virtual equipment at the position associated with the equipment skill trigger control and/or the equipment skill state control.

Optionally, the method further includes: determining game resource data of the target virtual equipment and replacement resource data of the replacement equipment corresponding to the target virtual equipment, and obtaining remaining resource data; obtaining consumable resource data by performing a resource calculation on the game resource data and the remaining resource data; and if the consumable resource data is less than the replacement resource data, determining that the target virtual equipment does not satisfy the replacement condition, and displaying the replacement equipment corresponding to the target virtual equipment in grey.

Optionally, after the displaying the equipment replacement control of the target virtual equipment at the position associated with the equipment skill trigger control and/or the equipment skill state control, the method further includes: if the target virtual equipment corresponds to a plurality of replacement equipment, determining valid replacement equipment and invalid replacement equipment from the replacement equipment; displaying the valid replacement equipment differentially, and displaying the invalid replacement equipment in grey; and determining a target position of the valid replacement equipment that is displayed differentially to be the position associated with the equipment skill trigger control and/or the equipment skill state control, and displaying the equipment replacement control of the target virtual equipment at the target position.

Optionally, the replacing, in response to the trigger operation on the equipment replacement control, the target virtual equipment with the corresponding replacement equipment includes: displaying, in response to a first trigger operation on the equipment replacement control, the replacement equipment corresponding to the target virtual equipment; determining, in response to a second trigger operation consecutive to the first trigger operation, that one piece of the valid replacement equipment as target replacement equipment; and replacing, in response to the second trigger operation terminating action, the target virtual equipment with the target replacement equipment.

Optionally, the setting the replacement equipment for the part or all of the virtual equipment in the initial equipment scheme includes: providing an equipment setting control on the virtual equipment setting interface; selecting selectable equipment in response to a third trigger operation on the selectable equipment; and setting, in response to a fourth trigger operation on the equipment setting control, the selectable equipment as the replacement equipment for the part or all of the virtual equipment in the initial equipment scheme.

Through the above manners, the target virtual equipment is bound to the equipment replacement behavior of the player through the provided equipment replacement control, without the need for the player to perform lengthy and complex operations for equipment replacement, simplifying the time cost and calculation cost invested by the player in the operation process when replacing the equipment, gaining the player more battle time in the case of fierce battle conditions, and also reducing the urgency sense for the player to switch back and forth between the battle and the store, which makes the immersion of the player in the game stronger. Further, by completing the equipment replacement behavior through the trigger operation on the equipment replacement control, the operation steps of the player in displaying, selecting, and replacing the replacement equipment are reduced, the replacement experience and battle experience of the player are enhanced, and the gap between the ordinary player and the high-level player is narrowed, which to a certain extent improves the reflux degree of the player.

Referring to FIG. 15, a program product 1500 for implementing the above-described method according to the embodiments of the present disclosure is described. The program product 1500 may use a portable compact disc read-only memory (CD-ROM) and include program code, and may be run on a terminal device, such as a personal computer. However, the program product of the present disclosure is not limited to this, and in this document, a readable storage medium may be any tangible medium that contains or stores a program that may be used by, or in combination with, an instruction execution system, apparatus, or device.

The program product may use any combination of one or more readable media. The readable medium may be a readable signal medium or a readable storage medium. The readable storage medium may, for example, be, but is not limited to, a system, apparatus or device that is electrical, magnetic, optical, electromagnetic, infrared, or semiconducting, or any combination of the above. More specific examples of the readable storage medium (a non-exhaustive list) include an electrical connection having one or more wires, a portable disc, a hard disc, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

The computer-readable signal medium may include a data signal propagated in baseband or as part of a carrier, which carries readable program code. Such propagated data signal may use a variety of forms, including, but not limited to, an electromagnetic signal, an optical signal, or any suitable combination of the above. The readable signal medium may also be any readable medium other than the readable storage medium, and this readable medium may send, propagate, or transmit a program for use by, or in combination with, an instruction execution system, apparatus, or device.

The program code included in the readable medium may be transmitted by using any suitable medium, including, but not limited to, wireless, wired, optical fiber, RF, etc., or any suitable combination of the above.

The program code for performing the operations of the present disclosure may be written in any combination of one or more program design languages, and the program design languages include object-oriented program design languages such as Java and C++, and also include conventional procedural program design language such as “C” language or a similar program design language. The program code may be executed entirely or partly on the user computing device, may be executed as an independent software package, may be executed partly on the user computing device and partly on the remote computing device, or may be executed entirely on the remote computing device or server. In the case of a remote computing device, the remote computing device may be connected to the user computing device via any kind of networks, such as a local area network (LAN) or a wide area network (WAN), or the remote computing device may be connected to external computing devices, for example, connected to external computing devices via the internet by use of an internet service provider.

After considering the specification and practices the disclosure disclosed herein, those skilled in the art will easily come up with other embodiments of the present disclosure. The purpose of the present disclosure is to cover any variations, uses, or adaptive changes of the present disclosure, which follow the general principles of the present disclosure and include common knowledge or commonly used technical means in the technical field that are not disclosed in the present disclosure. The specification and embodiments are only considered exemplary, and the true scope and spirit of the present disclosure are indicated by the claims.

1. A game equipment replacement method, comprising:
providing, by a terminal device, a virtual equipment setting interface on a graphical user interface of a game, wherein the graphical user interface is provided through the terminal device, the game comprises a game scene and a player virtual character in the game scene, the player virtual character is configured to perform a game action based on a game instruction received by the graphical user interface;
in response to a virtual equipment scheme setting operation on the virtual equipment setting interface, setting, by the terminal device, an initial equipment scheme for the player virtual character, and setting, by the terminal device, replacement equipment for part or all of virtual equipment in the initial equipment scheme;
providing, by the terminal device based on the initial equipment scheme, a shortcut equipment configuration control on the graphical user interface, and configuring, by the terminal device in response to a trigger operation on the shortcut equipment configuration control, corresponding virtual equipment for the player virtual character;
setting, by the terminal device on the graphical user interface in response to the player virtual character being configured with target virtual equipment, at least one of an equipment skill trigger control or an equipment skill state control of the target virtual equipment, wherein the equipment skill trigger control is used for actively triggering a game skill corresponding to the target virtual equipment, and the equipment skill state control is used for displaying a state of the game skill corresponding to the target virtual equipment;
displaying, by the terminal device in response to a preset display trigger event, an equipment replacement control of the target virtual equipment at a position associated with the at least one of the equipment skill trigger control or the equipment skill state control; and
replacing, by the terminal device in response to a trigger operation on the equipment replacement control, the target virtual equipment with corresponding replacement equipment.

2. The method according to claim 1, wherein the displaying the equipment replacement control in response to the preset display trigger event comprises:
determining, in response to the game skill corresponding to the target virtual equipment being in an unavailable state, whether the target virtual equipment satisfies a replacement condition of the replacement equipment corresponding to the target virtual equipment; and
displaying, in response to determining that the target virtual equipment satisfies the replacement condition, the equipment replacement control of the target virtual equipment at the position associated with the at least one of the equipment skill trigger control or the equipment skill state control.

3. The method according to claim 2, wherein the determining whether the target virtual equipment satisfies the replacement condition comprises:
determining game resource data of the target virtual equipment and replacement resource data of the replacement equipment corresponding to the target virtual equipment, and obtaining remaining resource data;
obtaining consumable resource data by performing a resource calculation on the game resource data and the remaining resource data; and
determining, in response to a value of the consumable resource data being greater than or equal to a value of the replacement resource data, that the target virtual equipment satisfies the replacement condition.

4. The method according to claim 2, wherein the determining whether the target virtual equipment satisfies the replacement condition comprises:
determining game resource data of the target virtual equipment and replacement resource data of the replacement equipment corresponding to the target virtual equipment, and obtaining remaining resource data;
obtaining consumable resource data by performing a resource calculation on the game resource data and the remaining resource data; and
determining, in response to a value of the consumable resource data being less than a value of the replacement resource data, that the target virtual equipment does not satisfy the replacement condition; and
the method further comprises:
displaying, in response to determining that the target virtual equipment does not satisfy the replacement condition, the replacement equipment corresponding to the target virtual equipment in grey.

5. The method according to claim 1, further comprising:
determining, in response to the target virtual equipment corresponding to a plurality of replacement equipment, valid replacement equipment and invalid replacement equipment from the plurality of replacement equipment;
displaying the valid replacement equipment differentially, and displaying the invalid replacement equipment in grey; and
determining a target position of the valid replacement equipment to be the position associated with the at least one of the equipment skill trigger control or the equipment skill state control, and displaying the equipment replacement control of the target virtual equipment at the target position.

6. The method according to claim 5, wherein the replacing, in response to the trigger operation on the equipment replacement control, the target virtual equipment with the corresponding replacement equipment comprises:
displaying, in response to a first trigger operation on the equipment replacement control, the replacement equipment corresponding to the target virtual equipment;
determining, in response to a second trigger operation consecutive to the first trigger operation, that one piece of the valid replacement equipment as target replacement equipment; and
replacing, in response to the second trigger operation terminating action, the target virtual equipment with the target replacement equipment.

7. The method according to claim 1, wherein the setting the replacement equipment for the part or all of the virtual equipment in the initial equipment scheme comprises:
providing an equipment setting control on the virtual equipment setting interface;
selecting selectable equipment in response to a third trigger operation on the selectable equipment; and
setting, in response to a fourth trigger operation on the equipment setting control, the selectable equipment as the replacement equipment for the part or all of the virtual equipment in the initial equipment scheme.

8. (canceled)

9. A non-transitory computer-readable storage medium, storing a computer program, wherein the computer program, when executed by a processor of an electronic device, enables the electronic device to perform a game equipment replacement method, wherein the method comprises:
providing a virtual equipment setting interface on a graphical user interface of a game, wherein the game comprises a game scene and a player virtual character in the game scene, and the player virtual character is configured to perform a game action based on a game instruction received by the graphical user interface;
in response to a virtual equipment scheme setting operation on the virtual equipment setting interface, setting an initial equipment scheme for the player virtual character, and setting replacement equipment for part or all of virtual equipment in the initial equipment scheme;
providing, based on the initial equipment scheme, a shortcut equipment configuration control on the graphical user interface, and configuring, in response to a trigger operation on the shortcut equipment configuration control, corresponding virtual equipment for the player virtual character;
setting, on the graphical user interface in response to the player virtual character being configured with target virtual equipment, at least one of an equipment skill trigger control or an equipment skill state control of the target virtual equipment, wherein the equipment skill trigger control is used for actively triggering a game skill corresponding to the target virtual equipment, and the equipment skill state control is used for displaying a state of the game skill corresponding to the target virtual equipment;
displaying, in response to a preset display trigger event, an equipment replacement control of the target virtual equipment at a position associated with the at least one of the equipment skill trigger control or the equipment skill state control; and
replacing, in response to a trigger operation on the equipment replacement control, the target virtual equipment with corresponding replacement equipment.

10. An electronic device, comprising:
a processor; and
a memory, configured to store an executable instruction of the processor; wherein
the processor, through executing the executable instruction, is configured to;
provide a virtual equipment setting interface on a graphical user interface of a game, wherein the game comprises a game scene and a player virtual character in the game scene, and the player virtual character is configured to perform a game action based on a game instruction received by the graphical user interface;
in response to a virtual equipment scheme setting operation on the virtual equipment setting interface, set an initial equipment scheme for the player virtual character, and set replacement equipment for part or all of virtual equipment in the initial equipment scheme;
provide, based on the initial equipment scheme, a shortcut equipment configuration control on the graphical user interface, and configure, in response to a trigger operation on the shortcut equipment configuration control, corresponding virtual equipment for the player virtual character;
set, on the graphical user interface in response to the player virtual character being configured with target virtual equipment, at least one of an equipment skill trigger control or an equipment skill state control of the target virtual equipment, wherein the equipment skill trigger control is used for actively triggering a game skill corresponding to the target virtual equipment, and the equipment skill state control is used for displaying a state of the game skill corresponding to the target virtual equipment;
display, in response to a preset display trigger event, an equipment replacement control of the target virtual equipment at a position associated with the at least one of the equipment skill trigger control or the equipment skill state control; and
replace, in response to a trigger operation on the equipment replacement control, the target virtual equipment with corresponding replacement equipment.

11. The electronic device according to claim 10, wherein the processor is specifically configured to:
determine, in response to the game skill corresponding to the target virtual equipment being in an unavailable state, whether the target virtual equipment satisfies a replacement condition of the replacement equipment corresponding to the target virtual equipment; and
display, in response to determining that the target virtual equipment satisfies the replacement condition, the equipment replacement control of the target virtual equipment at the position associated with the at least one of the equipment skill trigger control or the equipment skill state control.

12. The electronic device according to claim 11, wherein the processor is specifically configured to:
determine game resource data of the target virtual equipment and replacement resource data of the replacement equipment corresponding to the target virtual equipment, and obtain remaining resource data;
obtain consumable resource data by performing a resource calculation on the game resource data and the remaining resource data; and
determine, in response to a value of the consumable resource data being greater than or equal to a value of the replacement resource data, that the target virtual equipment satisfies the replacement condition.

13. The electronic device according to claim 11, wherein the processor is specifically configured to:
determine game resource data of the target virtual equipment and replacement resource data of the replacement equipment corresponding to the target virtual equipment, and obtain remaining resource data;
obtain consumable resource data by performing a resource calculation on the game resource data and the remaining resource data; and
determine, in response to a value of the consumable resource data being less than a value of the replacement resource data, that the target virtual equipment does not satisfy the replacement condition; and
the processor is further configured to display, in response to determining that the target virtual equipment does not satisfy the replacement condition, the replacement equipment corresponding to the target virtual equipment in grey.

14. The electronic device according to claim 10, wherein the processor is further configured to:
determine, in response to the target virtual equipment corresponding to a plurality of replacement equipment, valid replacement equipment and invalid replacement equipment from the plurality of replacement equipment;
display the valid replacement equipment differentially, and display the invalid replacement equipment in grey; and
determine a target position of the valid replacement equipment to be the position associated with the at least one of the equipment skill trigger control or the equipment skill state control, and display the equipment replacement control of the target virtual equipment at the target position.

15. The electronic device according to claim 14, wherein the processor is specifically configured to:
display, in response to a first trigger operation on the equipment replacement control, the replacement equipment corresponding to the target virtual equipment;
determine, in response to a second trigger operation consecutive to the first trigger operation, that one piece of the valid replacement equipment as target replacement equipment; and
replace, in response to the second trigger operation terminating action, the target virtual equipment with the target replacement equipment.

16. The electronic device according to claim 10, wherein the processor is specifically configured to:
provide an equipment setting control on the virtual equipment setting interface;
select selectable equipment in response to a third trigger operation on the selectable equipment; and
set, in response to a fourth trigger operation on the equipment setting control, the selectable equipment as the replacement equipment for the part or all of the virtual equipment in the initial equipment scheme.

17. The non-transitory storage medium according to claim 9, wherein the displaying the equipment replacement control in response to the preset display trigger event comprises:
determining, in response to the game skill corresponding to the target virtual equipment being in an unavailable state, whether the target virtual equipment satisfies a replacement condition of the replacement equipment corresponding to the target virtual equipment; and
displaying, in response to determining that the target virtual equipment satisfies the replacement condition, the equipment replacement control of the target virtual equipment at the position associated with the at least one of the equipment skill trigger control or the equipment skill state control.

18. The non-transitory storage medium according to claim 17, wherein the determining whether the target virtual equipment satisfies the replacement condition comprises:
determining game resource data of the target virtual equipment and replacement resource data of the replacement equipment corresponding to the target virtual equipment, and obtaining remaining resource data;
obtaining consumable resource data by performing a resource calculation on the game resource data and the remaining resource data; and
determining, in response to a value of the consumable resource data being greater than or equal to a value of the replacement resource data, that the target virtual equipment satisfies the replacement condition.

19. The non-transitory storage medium according to claim 17, wherein the determining whether the target virtual equipment satisfies the replacement condition comprises:
determining game resource data of the target virtual equipment and replacement resource data of the replacement equipment corresponding to the target virtual equipment, and obtaining remaining resource data;
obtaining consumable resource data by performing a resource calculation on the game resource data and the remaining resource data; and
determining, in response to a value of the consumable resource data being less than a value of the replacement resource data, that the target virtual equipment does not satisfy the replacement condition; and
the method further comprises:
displaying, in response to determining that the target virtual equipment does not satisfy the replacement condition, the replacement equipment corresponding to the target virtual equipment in grey.

20. The non-transitory storage medium according to claim 9, wherein the method further comprises:
determining, in response to the target virtual equipment corresponding to a plurality of replacement equipment, valid replacement equipment and invalid replacement equipment from the plurality of replacement equipment;
displaying the valid replacement equipment differentially, and displaying the invalid replacement equipment in grey; and
determining a target position of the valid replacement equipment to be the position associated with the at least one of the equipment skill trigger control or the equipment skill state control, and displaying the equipment replacement control of the target virtual equipment at the target position.

21. The non-transitory storage medium according to claim 20, wherein the replacing, in response to the trigger operation on the equipment replacement control, the target virtual equipment with the corresponding replacement equipment comprises:
displaying, in response to a first trigger operation on the equipment replacement control, the replacement equipment corresponding to the target virtual equipment;
determining, in response to a second trigger operation consecutive to the first trigger operation, that one piece of the valid replacement equipment as target replacement equipment; and
replacing, in response to the second trigger operation terminating action, the target virtual equipment with the target replacement equipment.
